(19) United States
(12) Patent Application Publication
(10) Pub. No.: US 2011/0054995 A1
(43) Pub. Date: Mar. 3, 2011

(54) CENTRAL SAVINGS MANAGEMENT SYSTEM

(76) Inventor: Mohsen Roostai, Beverly Hills, CA (US)

(21) Appl. No.: 12/902,453

(22) Filed: Oct. 12, 2010

Related U.S. Application Data
(60) Provisional application No. 12/902,453, filed on Aug. 18, 2010.

(51) Int. Cl. G06Q 30/00

(52) U.S. Cl. 705/14.38; 705/16

(57) ABSTRACT

A central savings management system and method is provided. A central savings management system is comprised of a data storage device with a storage medium associated with a customer, a point of sale device for receiving currency in at least a first transaction associated with at least one commercial environment from the customer, the point of sale device operatively coupled with the data storage device, wherein the point of sale device displays an option to retain a portion of the currency from the at least a first transaction, and a management system operatively coupled to the point of sale device, configured to receive the portion of the currency from the at least a first transaction, the management system including a processor, a memory, a server, a customer database communicatively linked with the at least one commercial environment storing the portion of the currency from the at least a first transaction, and a web module for displaying portions from a plurality of commercial environments to the customer.

### CROSS-REFERENCE TO RELATED APPLICATIONS

This United States Non-Provisional Patent Application claims priority under 35 U.S.C. §119(e) to U.S. Provisional Patent Application Ser. No. 61/374,721 filed Aug. 18, 2010, and is incorporated by reference as if fully set forth within.

### BACKGROUND

1) Field of the Invention

The invention relates to financial savings in a commercial environment. More particularly, the invention relates to method and system of aggregating portions of financial transactions in a plurality of commercial environments.

2) Discussion of the Related Art

Generally, commercial establishments visited by customers have one or more point-of-sale (hereinafter “POS”) terminals. These POS systems in large retail store chains, e.g., supermarket chains, process large amounts of customer transactions per store per week. Such POS terminals are used by personnel such as cashiers and clerks to perform various functions, such as calculating the total price of a purchase for one or more products and/or services and calculating the amount of change due to a customer. A POS terminal may also track purchases made and adjust a database of stored inventory accordingly.

A retail store's business strategies and marketing initiatives are generally integrated with the store's POS terminals. This is because, it is at the point of sale that the store often has its best opportunity to exchange information and gather data from the customer. Many times a merchant may desire to offer to sell a customer or user a product or service in addition, or related to, the product being purchased by the customer while the customer is shopping at the merchant or shopping on-line via a merchant's commercial Internet site.

Retail stores and manufacturers have broadly utilized database technology in the development of promotions to help move product as well as stimulate interest in new products. These promotions may include stamps, coupons, and the like, in order to stimulate customer interest. However, commercial establishments desire to more directly target the consumer.

Further, many times a customer in a retail environment may see a product that exceeds the funds that customer has at that moment, however, in leaving that environment forget to plan and save to ultimately purchase the product. Along similar lines, customers may also purchase items they can afford and at the same time want to save for future items within the same retail store at a later date. This scenario may play out at a variety of commercial establishments.

Thus, there is a need to centralize saving mechanisms for commercial establishments and provide customers with the ability to save funds specific and relevant to the location and, at the same time, provide commercial establishments the ability to more directly target consumers.

### BRIEF DESCRIPTION OF THE DRAWINGS

The invention is described by way of example with reference to the accompanying drawings where:

FIG. 1 illustrates a central savings management system.

FIG. 2 illustrates an embodiment of the central savings management system.

FIG. 3 illustrates a management system connected to a customer and a point of sale device in a commercial environment.

FIG. 4 illustrates an embodiment of a web module.

FIG. 5 illustrates another embodiment of the web module.

FIG. 6 illustrates another embodiment of the web module.

FIG. 7 illustrates another embodiment of the management system.

FIG. 8 illustrates an embodiment of a message module.

### DETAILED DESCRIPTION OF THE INVENTION

The present invention is described below with reference to diagrams of methods and systems to manage and track portions from cash purchases at a retail point of sale by customers. At the same time, the invention provides merchants and customers the ability to further interact with the commercial environment and each other. It is understood that each block of the illustrations may be implemented by means of analog or digital hardware and computer program instructions.

These computer program instructions may be provided to a processor of a general purpose computer, special purpose computer, Application Specific Integrated Circuit (“ASIC”), or other programmable data processing apparatus, such that the instructions, which execute via the processor of the computer or other programmable data processing apparatus, implements the functions/acts specified in the block diagrams or operational block or blocks.

The World Wide Web (“Web”) used herein refers generally to both (i) a distributed collection of interlinked, user-viewable hypertext documents (commonly referred to as web documents or web pages) that are accessible via the Internet, and (ii) the client and server software components which provide user access to such documents using standardized Internet protocols. The primary standard protocol for allowing applications to locate and acquire web documents is HTTP, and the web pages are encoded using HTML. However, the terms “Web” and “World Wide Web” are intended to encompass markup languages and transport protocols which may be used in place of (or in addition to) HTML and HTTP.

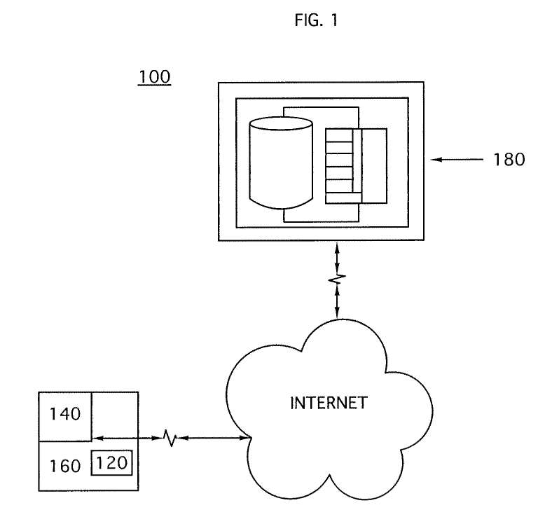

FIG. 1 illustrates a central savings management system 100. The central savings management system 100 (“CSMS”) is comprised of a data storage device 120 having a storage medium associated with a customer, a point of sale device 140 (“POS”) for receiving currency in at least a first transaction, at least one commercial environment 160, and a management system 180 operatively coupled to the POS 140, the CSMS 100 of which can be wired, non-wired or a combination thereof.

The CSMS 100 receives and accounts for value in currency. The currency in a transaction can include any known type of currency, in that the term currency can include, but are not limited to, cash, credit card, check, and debit card purchases. The CSMS 100 is designed to accommodate and include any alternatives wherein value is exchanged for something else of value. That value is recognized by the CSMS 100 and stored.

The data storage device 120 is broadly defined to include any medium storing identification information on a memory. In an embodiment, the data storage device 120 can be a transceiver. However, the data storage device 120 also extends to a customer retaining identification information including but not limited to driver's license number, phone number, password, biometric identifiers, address or any other governmental or non-governmental identification. Each embodiment can be used to interact with the POS 140 using means of information transfer such that the customer is identified by the system. Hereinafter, “data storage device” and “customer” are used interchangeably with reference numeral 120 and can be thought of as anything that broadly stores information aiding in identification.

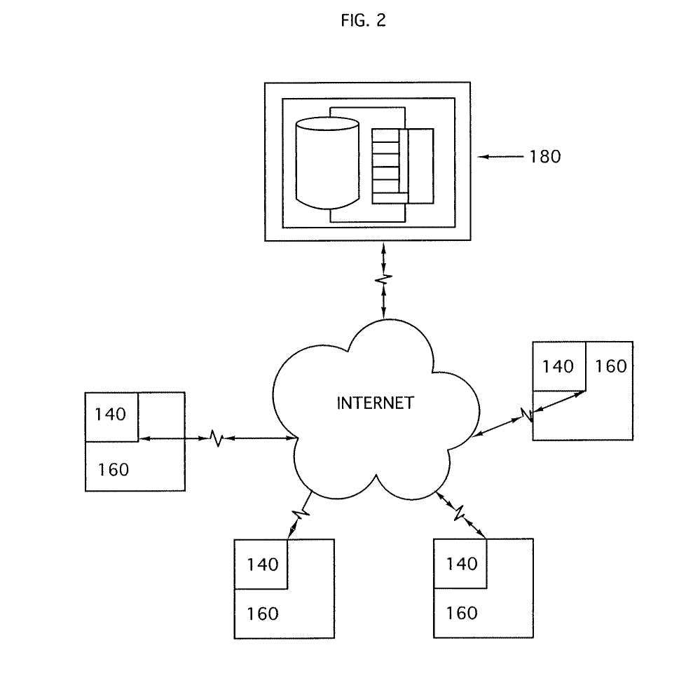

FIG. 2 illustrates an embodiment of the CSMS 100, in aggregating the at least one commercial environment 160. The at least one commercial environment 160 contains at least one POS 140 and represents any retail environment where currency is exchanged for goods and/or services, or where “financial transactions” are initiated. In an embodiment, the at least one commercial environment 160 can include online e-commerce as well as brick and mortar stores.

It is important to point out that in an e-commerce embodiment of the at least one commercial environment 160, the POS 140 is not necessarily a tangible device, but rather a calculating algorithm and a web interface, or the equivalent. As such, the POS 140 is designed by the CSMS 100 to exist in both embodiments and operate equivalently. The CSMS 100 is able to manage a plurality of financial transactions in a variety of different environments, as described above, and centralize these transactions in a hub for the customer 120.

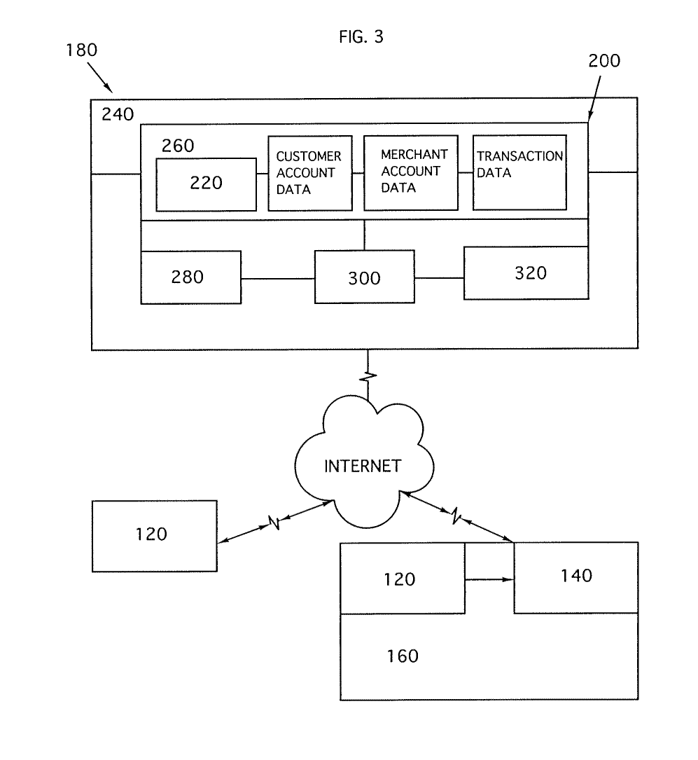

FIG. 3 illustrates an embodiment of the management system 180 (“MS”). The MS 180 includes a processor 200, a memory 220, a server 240, a customer database 260, a web module (“WM”) 280, message module (“MM”) 300, and a customer module (“CM”) 320. The modules of the MS 180 are all operatively connected, and can be distributed in a single location or plural locations across a network.

The MS 180 is communicatively linked with the at least one commercial environment 160, and is configured to receive and store a portion, basically the data equivalent, of the currency from the at least a first cash transaction on the customer database 260. At the same time, the MS 180 makes accessible to the customer 120 and commercial environment 160 specific modules within the MS 180, as described further herein.

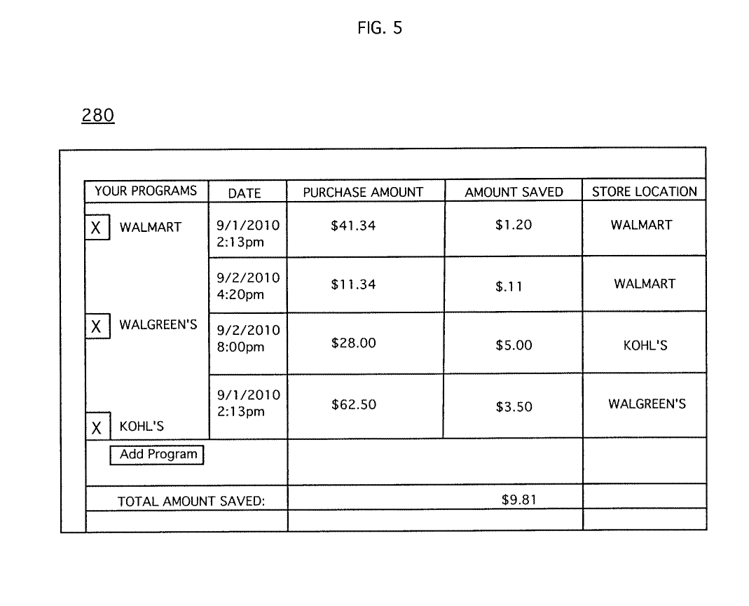

The server 240 is designed to process requests within the system and deliver data to other (client) computers over a local network or the Internet. Servers typically are configured with additional processing, memory and storage capacity to handle the load of servicing clients. As described herein, the server 240 responds to requests from a variety of different modules within the MS 180, such as requests from the POS 140, the data storage device 120, the CM 320, the MM 300, and the retail module (“RM”) 340 (illustrated in FIG. 5).

The customer database 260 can contain accounts associated with the customer 120 in the at least one commercial environment 160. In an embodiment, the customer database 260 can be a plurality, and therefore associated with a plurality of commercial environments 160.

The customer database 260 can store customer account data. This data includes information connecting the customer with the CSMS 100, as described further herein, as well as data which is representative of the merchant and the customer 120 engaging in financial transactions at the POS 140. This data can be, at a minimum, in the form of storing product(s) and/or service(s) names or brands, transactions, value, as well as the time and location of the purchase.

The MS 180 is configured to store the numerical values of the portions of the currency from the at least a first transaction made at the POS 140. The portion, in an embodiment, can include storing the value of change from at least a first transaction. In an embodiment, the portion can include a contribution from the customer 120, wherein the CM 320 displays an option on the POS 140 requesting input from the customer 120, as to whether the customer 120 is interested in rounding up a financial transaction to the nearest dollar, wherein that change value would be stored in an account in the customer database 260.

In another embodiment, the CM 320 can display on the POS 140 specific values to contribute based on the amount of money received at the POS 140, or request input from the customer 120 as to any contribution to the account associated with the customer database 260. The CM 320 is also associated with the generation of user logins and password functionality, further described herein.

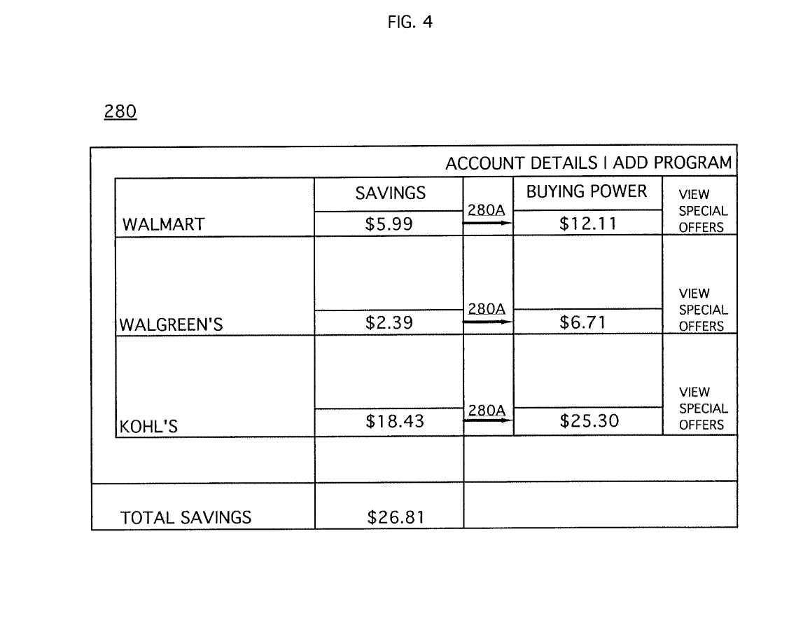

FIG. 4 illustrates an embodiment of a graphical user interface (“GUI”) of the WM 280. In this embodiment, the WM 280 provides the customer 120 the ability to access, through the CM 320, the representations of change or the contributions on a specific account within the customer database 260 or a variety of accounts on the customer database 260. Here, the WM 280 provides to the customer 120 the interface and the displays associated with savings from three commercial stores for a particular customer 120, as well as the total accumulated savings for the customer 120 for all three commercial environments 160.

In an embodiment, the customer 120, as described herein, through the CM 320, and in view of the WM 280 allows customers 120 to make cash contributions to respective accounts contained in the customer database 260. In this particular embodiment, the contribution would be added to the “savings” (shown in FIG. 4) towards a particular store or split up amongst a variety of commercial stores. Further features in FIG. 4 such as “Account Details” and “Buying Power” will be referenced and described in more detail herein.

FIG. 4 further illustrates a feature called “Add Program.” This feature allows the customer 120 to include a participating commercial environment 160. The feature allows the customer 120 to expand on the current network and allow for further centralizing of each respective financial transaction.

FIG. 5 illustrates the WM 280 in another embodiment. In accessing the GUI of FIG. 5, a hyperlink is placed within the term “Account Details” in FIG. 4. In this embodiment, the WM 280 has the capability to delineate customer 120 financial transactions in a variety of commercial environments 160. As discussed above, information collected at the POS 140 is stored at the customer database 260. The WM 180 illustrates this data in a GUI for the customer 120, allowing the customer 120 to view their financial activity. As described above, this information illustrates the store, the date and time of the purchase, the amount of the purchase, and the amount saved to date at that particular location.

The WM 280 basically provides informational content over a network via a web site using the standard protocols of the World Wide Web. Typically, a web site corresponds to a particular Internet domain name, such as “www.yahoo.com,” and includes the content associated with a particular organization. As used herein, the term “web module” generally includes the hardware/software server components that provide the informational content over the network, and the “back end” hardware/software components, including any non-standard or specialized components such as a database and search engines, that interact with the server components to perform services for users accessing the web site.

FIG. 5 further illustrates the feature found in the WM 280 embodiment in FIG. 4, “Add Program,” as describe above, as well as total savings across a spectrum of commercial environments 160. The large distinction between embodiments in FIGS. 4 and 5 are discussed below.

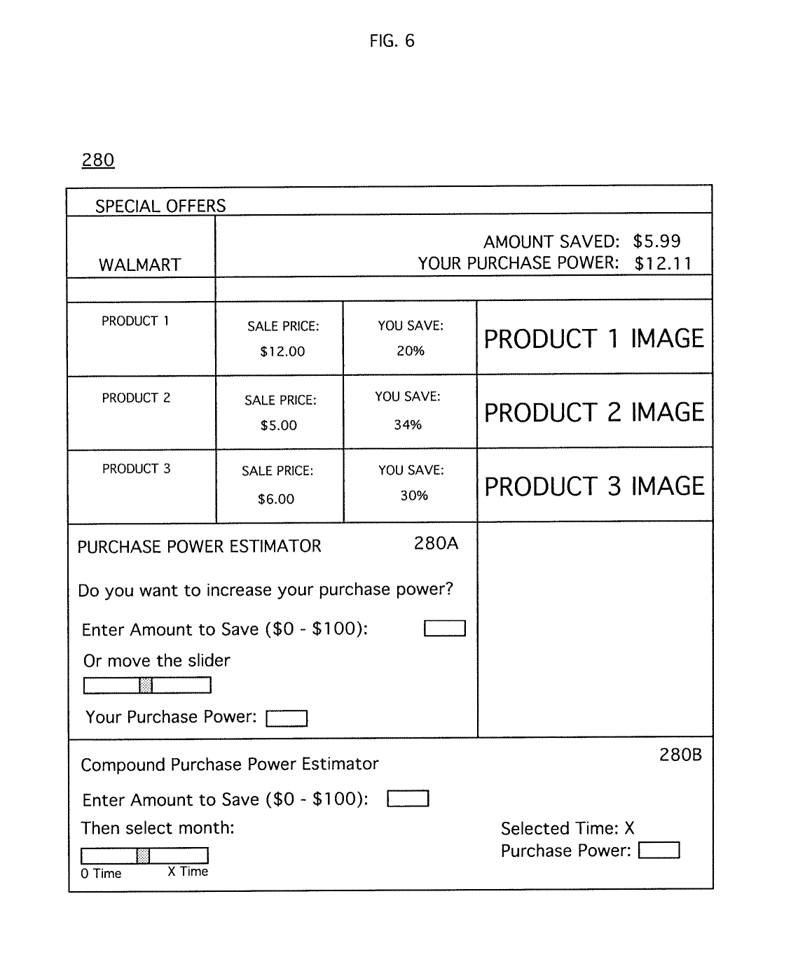

FIG. 6 illustrates another embodiment of the WM 180. In this embodiment, the “View Special Offers” option is chosen, which is specifically linked to a commercial environment 160, as depicted in FIG. 4. The customer 120 is taken to another GUI illustrating specific products provided by the at least one commercial environment 160.

As illustrated in FIG. 4 and FIG. 6, the WM 180 provides a calculation, or an increased portion option, specific to each commercial environment 160, basically the notion of “Purchase Power Estimator” or “Buying Power Estimator” 280A. Illustrated in FIG. 4, a customer 120 can view the Purchase Power Estimator 280A calculated and provided by a particular commercial environment 160. In seeing that, the customer 120 is then provided a hyperlink under View Special Offers as described above.

Further illustrated in FIG. 6 is the “Compound Purchase Estimator” 280B. This feature allows the customer 120 the ability to actually calculate the amount needed to contribute towards a specific product, over time. Basically, the Compound Purchase Estimator is a contribution duration option provided by the system. For instance, the customer 120 can enter an amount to save per month. However, as indicated above, with the purchase power estimator, the commercial environment 160 can provide purchase power over a specific time. Therefore, with the customer 120 contribution per month, the customer is able to extrapolate the savings over a period time, resulting in a purchase power of amount saved over time and purchase power provided over time. This feature allows a customer 120 the ability to figure out when the total purchase price for a product will be obtained.

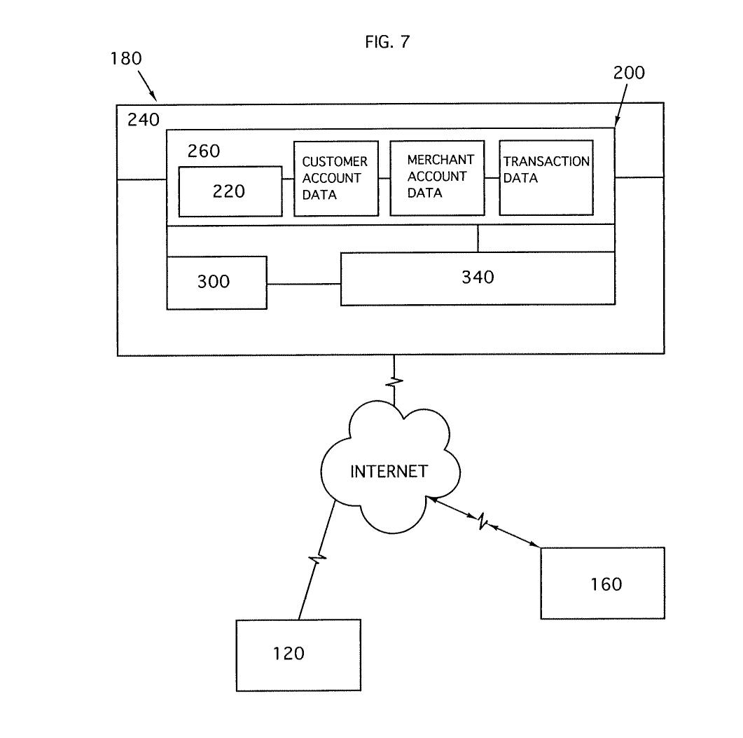

The above features of the MS 180 are specifically provided for in the RM 340, illustrated in FIG. 7. The RM 340 provides the MS 180 capability of interacting with the commercial environment 160. In this specific embodiment, the commercial environment 160 is able to log into the system and provide a calculation specific to the amount saved in the account within the customer database 260. For instance, in FIG. 6 it is apparent that an amount saved of $5.99 equals a purchase power of $12.11 as provided by WALMART.

Further illustrated in FIG. 6, the MS 180 also provides the ability for the customer 120 to increase purchase power above the amount saved. To this end, the WM 280, through the CM 320, provides an option to enter an amount to increase purchase or buying power through a text box, or provides a “slide bar” or “scroll bar,” allowing the customer 120 to instantly see how much buying or purchasing power results from a specific contribution. This kind of feature can be implemented in Flash or similar programs and embedded into hypertext markup language (“html”).

The above feature further applies to the Compound Purchase Estimator 280B feature. Much like the Purchase Power Estimator 280A, the customer 120 has the ability to actually calculate the purchase power. Of course, the distinction is that the Compound Purchase Estimator 280B provides the amount needed to contribute towards a specific product, over time. However, as above, the at least one commercial environment 160 can provide purchase power over a specific time.

The at least one commercial environment 120 will hold funds in its own account within the customer database 260 in the MS 180. When a consumer 120 returns to that particular commercial environment 120, and has reached the POS 140 with items for purchase, the cashier will scan the customer's 120 card or obtain other account identification information such as email addresses, phone numbers or others, prior to the financial transaction.

Depending on the embodiment, a card can either be scanned using a bar code reader, Radio Frequency Identification (“RFID”) or swiped from a magnetic stripe on card, or other identification as described herein can be used to retrieve by the server 240 the associated value in that particular commercial environment 160.

The value which is represented on the customer database 260 for that specific commercial environment 160 can be deducted in an embodiment where the customer 120 is interested in using that balance for a specific purchase. Further, account funds may be redeemed at any time at the retailer for the actual face value. This action, of course, would require both identification and password confirmation. Funds may also be converted into purchasing power at the commercial environment 160 for merchandise therein.

Further illustrated in FIG. 7 (see also FIG. 3), the MM 300 is accessible by the customer 120, the commercial environment 160, or the administrator of the CSMS 100. Once accessed, the function of the MM 300, in an embodiment, is to supply messages or notices in the form of advertisements from the commercial environment 160 regarding new products and services and related transactions of the customer 120, or any administrative messages relevant to the CSMS 100 itself.

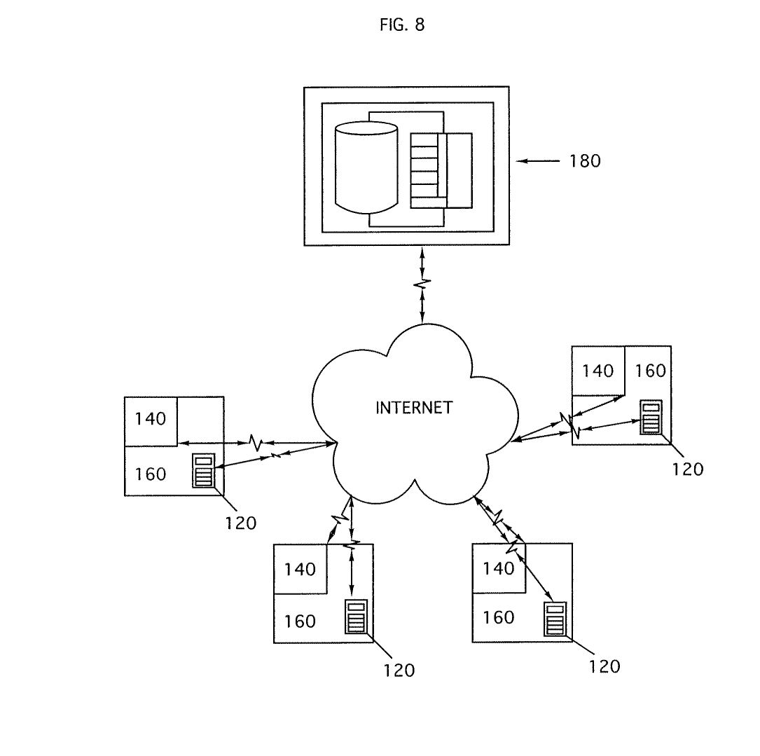

In an embodiment, the customer 120 can set preferences within the CM 320. The preferences filters the MM 300 with respect to what messages the customer 120 receives and does not receive. The customer 120 can have messages sent that include receipts from any redemption from or contribution to the CSMS 100 or in general, any accounting involved in the system, including the balance, or in general, any message containing information displayed on the WM 280. In an embodiment, the customer 120 can receive receipts for each cash contribution in print at the POS 140 and/or by digital text message and/or email. This embodiment is specifically illustrated in FIG. 8.

The commercial environment 160 may wish to create an incentive/loyalty program around the financial transaction, intending to offer the consumer even greater value than just the balance of change on the associated account. This end is reflected in the terms buying power or purchase power in the Purchase Power Estimator 280A. In an embodiment, the commercial environment 160 could match all or some of the portion of the funds collected in that environment, and provide an advertisement through the MM 300 reflecting the same.

In creating an incentive/loyalty program, the commercial environment 160 requests the customer 120 to sign up for an account. For example, a new account can be created by a variety of means including but not limited to fingerprints, retinal scan or other identifying biometric means. RFID can also be used by the customer 120 for identification and in enrolling in such a program.

RFID tags contain at least an integrated circuit for storing and processing information, modulating and demodulating a radio frequency signal and an antenna for receiving and transmitting the signal. These RFID tags can be embedded in something owned by the customer 120. In this embodiment, data storage device 120 may be more appropriate.

In addition to the above identification means, in an embodiment, there can be pre-existing devices already associated with a customer as a data storage device 120 to aid in signing up an account. For example, many state driver licenses now include a magnetic stripe containing the relevant driver license information. As such, in an embodiment, the CSMS 100 may use the driver's license. In an embodiment, upon first use the owner of the driver's license would swipe the card in a card reader and a new account would be created and populated with the user's information and change to be credited to the account. In another embodiment, a personal identification number (PIN) can also be used. In this embodiment, data is not saved to the driver's license, but rather stored on the card administrator's systems for future access.

In another embodiment, a pre-existing card with updateable information may be used. For example, some cities now use smart cards or other devices for mass transit payments or toll payments. In an embodiment, the same system used to track these payments is used as an administrator. Thus, when a customer 120 receives change, the customer 120 may elect to have the change credited to the user's mass transit account. This particular feature is accomplished by way of the CM 320.

As mentioned above, a mobile telephone may also be used as a data storage device 120. The account generated may or may not be the same billing account associated with the mobile telephone service provider. Instead the mobile device number (e.g., the telephone number) or identification capabilities (many mobile devices now incorporate RFID or other unique electronic identification means) may be used to associate the phone's owner with an account and its balance

In use, the CSMS 100 provides a method of managing customer transactions from POS 140 devices in commercial environments 160. In doing so, a customer 120 is identified by the CSMS 100 by the means described herein, in a participating commercial environment 160.

The CSMS 100 receives data from a data storage device 120 having a storage medium associated with the customer 120, in a particular embodiment, from the POS in the commercial environment 160. The data is transmitted to the MS 180 where the MS 180 identifies the customer 120. As stated previously, the MS 180 is operatively coupled to the POS 140. The POS 140 receives currency in at least a first transaction associated with at least one commercial environment 160. In an embodiment, the CM 320 transmits information to display an option to retain a portion of the currency from the at least a first transaction. In another embodiment, the display can include an option on the POS 140 to retain the portion of the currency that is an amount equal to the change due from the at least one first transaction.

In yet another embodiment, the display can be an option on the POS 140 to retain the portion of the currency is an amount the customer 120 would like to contribute above the at least one first transaction. The customer database 260 then stores the value of the portion of the currency from the at least one first transaction. As stated above, the amount ultimately displayed on the POS 140, can be controlled or chosen by the customer 120 through the CM 320.

As further provided by the MS 180, the commercial environment 160 is able to access the MM 300 through the RM 340 and provide incentives on products and services to the customer based on data in the customer database 260, which in an embodiment, can include data specific to the at least one first transaction associated with the at least one commercial environment 160.

In an embodiment, the commercial environment 160 can provide incentives to the customer 120 by transmitting the incentive by at least one of short messaging service, electronic mail, and multimedia messaging service through the MM 300. Of course, the mode of transmission through the MM 300 is designed to encompass all forms of messaging technology.

Ultimately, the customer 120 is then able to use the respective portions of currency saved in the system, in redeeming the portion in a second transaction in the at least one commercial environment 160. Here, the benefits from the commercial environment 160 are realized. In an embodiment, in redeeming the portion, the commercial environment 160 can be all stores of the same chain, or any participating commercial environment 160, which can encompass a variety of different retail and commercial stores.

Generally, the MS 180 provides the ability for the commercial environment 160 and the customer 120 to interact. For example, the RM 340, after successful login, provides access to customer databases 260 within that particular environment. The MS 180 further provides for communication, either related to or unrelated to that particular data. Therefore, the commercial environment 160 is able to directly interact with the customer 120.

One example of interaction is the purchase power option. The RM 340 provides for the purchase power option to the customer 120 on a network, as an additional incentive to purchase specific products. This option, in an embodiment, can also be displayed at the POS 140. As described above, this feature is set specifically by each at least one commercial environment 160.

Further, the MS 180 provides functionality through CM 320 for the customer 120 as that seen for the at least one commercial environment 160. The CM 320 also functions as a secure login module for the customer 120. The customer 120, in an embodiment, can create respective displays seen on the POS 140. For instance, the customer 120 can input into the CM 320 the ability to automatically store the change from a financial transaction. Further, the customer 120 can input specific denominations, for example, display on the POS 140 the options to store $10, $20 or $30. Further, in another embodiment, the customer 120 can always request the CSMS 100 to round up all transactions or even transfer portions between respective customer databases in different participating commercial environments 160. Of course, such an amount transferred can result in different purchase power estimator calculations.

An advantage of the invention as described herein, is the ability to interconnect the customer 120 and the commercial environment 160. The customer 120 receives an advantage of storing portions of currency, which can include change or any denomination on a commercial environment related database 260. This advantage is particularly useful in saving for specific items with the commercial environment 160, as well as simply storing change and not keeping it on one's person.

Another advantage of the invention is the ability of the invention to aggregate participating commercial environments 160 in a central hub, providing better, more efficient, management of stored funds. In the CSMS 100, the customer 120 can transfer savings from one commercial environment 160 to another, in that, the goods or services can be completely unrelated, yet, the funds will transfer into and can be redeemed in another environment, including the same environment.

A further advantage of the invention is that the merchant has access to the MS 180 through the RM 340. It is through the RM 340, connected to the MM 300, that the commercial environment 160 is able to access and communicate to the customer 120. An advantage being the MM 300 providing a variety of communication means, time preferences and other specific features in message delivery.

Two further advantages of the invention aimed, at the customer 120, are the Purchase Power Estimator 280A and the Compound Purchase Calculator 280B. These particular features are algorithmic calculations within the MS 180 and allow for the calculation of savings towards a particular product or service, and the protracted or the specific savings towards a particular product or service over time, respectively.

The calculations are provided by the commercial environment 160 and allow for the customer 120 to determine what additional amount each commercial environment 160 is offering over the specific savings amount in the particular account, as well as what periodic monetary contributions could result in a specified length of time, specific to a product or service.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art without departing from the spirit and scope thereof. Thus, it is intended that the present invention cover the modifications and variations of this invention provided they come within the scope of the appended claims and their equivalents.

What is claimed:

1. A method of managing customer transactions from point-of-sale devices in commercial environments, the method comprising:
receiving data from a data storage device with a storage medium associated with the customer from a point-of-sale device in at least one commercial environment;
receiving currency in at least one first transaction associated with the at least one commercial environment from the customer;
displaying an option on the point-of-sale device to retain a portion of the currency from the at least one first transaction;
storing the portion of the currency from the at least one first transaction in a customer database communicatively linked with the at least one commercial environment; and
displaying the portion from the at least one first transaction associated with the at least one commercial environment to the customer on a network.

2. The method of claim 1 wherein the data storage device is associated with the at least one commercial environment.

3. The method of claim 1 including displaying an option on the point-of-sale device to retain the portion of the currency that is an amount equal to the change due from the at least one first transaction.

4. The method of claim 1 including displaying an option on the point-of-sale device to retain the portion of the currency that is an amount the customer would like to contribute above the at least one first transaction.

5. The method of claim 1 including providing incentives to the customer based on data in the customer database specific to the at least one first transaction associated with the at least one commercial environment.

6. The method of claim 5 including providing incentives to the customer by transmitting by at least one of short messaging service, electronic mail, and multimedia messaging service.

7. The method of claim 5 including providing access to the at least one commercial environment and the ability to provide incentives to the customer.

8. The method of claim 1 including storing related transaction data in the customer database associated with the at least one first transaction communicatively linked with the at least one commercial environment.

9. The method of claim 1 including providing the ability to transfer the portion between respective customer databases in commercial environments.

10. The method of claim 1 including redeeming the portion in a second transaction in the at least one commercial environment.

11. The method of claim 1 including displaying an option to an increased portion to the customer specific to at least one of a good and service of the at least one commercial environment.

12. The method of claim 4 including displaying an option to contribute at least two portions over a fixed duration specific to at least one of a good and service of the at least one commercial environment.

13. A central savings management system, comprising:
a data storage device with a storage medium associated with a customer;
a point of sale device for receiving currency in at least a first transaction associated with at least one commercial environment from the customer, the point of sale device operatively coupled with the data storage device, wherein the point of sale device displays an option to retain a portion of the currency from the at least a first transaction; and
a management system operatively coupled to the point of sale device, configured to receive the portion of the currency from the at least a transaction, the management system including a processor, a memory, a server, a customer database communicatively linked with the at least one commercial environment storing the portion of the currency from the at least a first transaction, and a web module for displaying portions from a plurality of commercial environments to the customer.

14. The system of claim 13 wherein the data storage device is associated with the at least one commercial environment.

15. The system of claim 13 wherein the management system includes a customer module displaying an option on the point-of-sale device to retain the portion of the currency that is an amount equal to the change due from the at least one first transaction.

16. The system of claim 13 wherein the management system includes a customer module displaying an option on the point-of-sale device to retain the portion of the currency that is an amount the customer would like to contribute.

17. The system of claim 13 wherein the management system includes a messaging module for providing incentives to the customer based on data in the customer database specific to the at least one first transaction associated with the at least one commercial environment.

18. The system of claim 17 wherein the messaging module provides incentives to the customer by transmitting by at least one of short messaging service, electronic mail, and multimedia messaging service.

19. The system of claim 17 wherein the management system includes a retail module for providing access to the at least one commercial environment and the ability to provide incentives to the customer through the messaging module.

20. The system of claim 13 wherein the customer database includes related transaction data associated with the at least one first transaction communicatively linked with the at least one commercial environment.

21. The system of claim 13 wherein the management system includes a customer module for providing the ability to transfer the portion between respective customer databases in commercial environments.

22. The system of claim 13 wherein the web module includes an increased portion option to the customer specific to at least one of a good and service of the at least one commercial environment.

23. The system of claim 16 wherein the web module includes an contribution duration option specific to at least one of a good and service of the at least one commercial environment.

24. A method of managing customer transactions from point-of-sale devices in commercial environments, the method comprising:
receiving data from a data storage device having a storage medium associated with the customer from a point-of-sale device in at least one commercial environment;
receiving currency in at least one first transaction associated with the at least one commercial environment from the customer;
storing the portion of the currency automatically from the at least one first transaction in a customer database communicatively linked with the at least one commercial environment; and
displaying the portion from the at least one first transaction associated with the at least one commercial environment to the customer.

25. A central savings management system, comprising:
a data storage device having a storage medium associated with a customer;
a point of sale device for receiving currency in at least a first transaction associated with at least one commercial environment from the customer, the point of sale device operatively coupled with the data storage device; wherein the point of sale device automatically retains a portion of the currency from the at least a first transaction; and
a management system operatively coupled to the point of sale device, configured to receive the portion of the currency from the at least a first transaction, the management system including a processor, a memory, a server, a customer database communicatively linked with the at least one commercial environment storing the portion of the currency from the at least a first transaction, and a web module for displaying portions from a plurality of commercial environments to the customer.

26. A method of managing customer transactions from point-of-sale devices in commercial environments, the method comprising:
receiving data from a data storage device with a storage medium associated with the customer from a point-of-sale device in at least one commercial environment;
receiving currency in at least one first transaction associated with the at least one commercial environment from the customer;
displaying an option on the point-of-sale device to retain a portion of the currency from the at least one first transaction; and
storing the portion of the currency from the at least one first transaction in a customer database communicatively linked with the at least one commercial environment.
